(19) United States
(12) Patent Application Publication
(10) Pub. No.: US 2026/0237377 A1
(43) Pub. Date: Aug. 13, 2026

(54) METHOD AND SYSTEM FOR ZERO-SHOT SPEAKER-ADAPTIVE SPEECH SYNTHESIS

(71) Applicant: NewSouth Innovations Pty Limited, Sydney, New South Wales (AU)

(72) Inventors: Sanjay Kumar Jha, Sydney, New South Wales (AU); Wenbin Wang, Sydney, New South Wales (AU); Yang Song, Sydney, New South Wales (AU)

(21) Appl. No.: 19/474,639

(22) PCT Filed: Sep. 19, 2023
(86) PCT No.: PCT/AU2023/050900

§ 371 Date: Oct. 10, 2025

(30) Foreign Application Priority Data
Apr. 11, 2023 (AU) 2023901043

(51) Int. Cl. G10L 13/033; G10L 13/08

(52) U.S. Cl. CPC G10L 13/033; G10L 13/08

(57) ABSTRACT

There is provided a method for synthesizing a speech waveform from text data. The method comprises: determining, from the text data, a phoneme sequence; obtaining a reference speech waveform comprising a high-level speech representation of a reference speaker speaking a reference speech; applying a trained neural network to the high-level speech representation to extract speaker embeddings; and determining, from the speaker embeddings and the phoneme sequence, a synthesized speech waveform indicative of the reference speaker speaking the text data.

### CROSS-REFERENCE TO RELATED APPLICATIONS

The present application claims priority from Australian Provisional Patent Application No 2023901043 filed on 11 Apr. 2023, the contents of which are incorporated herein by reference in their entirety.

### TECHNICAL FIELD

Embodiments generally relate to systems, methods, devices and computer-readable media for synthesizing a speech waveform from text data. In particular, embodiments relate to synthesizing a speech waveform having the speech characteristics of a reference speaker the from text data.

### BACKGROUND

The artificial production of human speech by speech synthesis software is a complex process. One form of speech synthesis comprises text-to-speech synthesis in which a software model synthesises human speech based on a body of normal language text. Speech synthesis models may also be configured to synthesise human speech from symbolic linguistic representations, like phonetic transcripts.

The performance of a general-purpose speech synthesis model is evaluated by the model's ability to articulate utterances so that listeners hear and understand them clearly. Additionally, because a speaker-adaptive speech synthesis model needs to synthesize speech from text according to a specific human voice, a speaker-adaptive speech synthesis model may undergo an additional evaluation criterion in relation to the similarity of the voice characteristics of the synthesized voice to the reference speaker's actual voice.

Speech synthesis software models may comprise trained neural networks. Speech synthesis software models may learn to synthesize speech for speakers within a training dataset of speeches by known speakers. The speech synthesis models learn to synthesize speech by learning the unique rhythm (speaking rate) and timbre (voice characteristics) of the known speakers from large volumes of training data during training.

An example speech synthesis model VITS, which is described in reference [3], comprises a conditional variational autoencoder with adversarial learning for end-to-end text-to-speech. The VITS model can synthesize high-quality speech for in-dataset speakers by utilizing the uncertainty modelling over latent variables and adversarial training.

The use of uncertainty modelling over latent variables and adversarial training may be unsuitable for synthesizing speech for unseen speakers, hence may be unable to meet the increasing demand for personalized speech synthesis. Furthermore, the majority of present speech synthesis machine learning models utilise a considerable volume of data to comprehend the unique voice of a speaker. Additionally, obtaining a substantial amount of data to train the model may often not be a possible for many applications/users.

It is desired to address or ameliorate one or more shortcomings or disadvantages associated with the prior art, or to at least provide a useful alternative.

Throughout this specification the word ‘comprise’, or variations such as ‘comprises’ or ‘comprising’, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY

The present embodiments relate to the synthesis of speech waveforms, based on text data, wherein the speech waveforms emulate the characteristics of a specific speaker voice. More specifically, the disclosed embodiments involve the extraction of comprehensive voice features from seconds of speech waveforms from a reference speaker. These features are then utilized to produce natural-sounding speech waveforms from arbitrary text data.

According to one aspect, there is provided a method for synthesizing a speech waveform from text data. The method comprises: determining, from the text data, a phoneme sequence; obtaining a reference speech waveform comprising a high-level speech representation of a reference speaker speaking a reference speech; applying a trained neural network to the high-level speech representation to extract speaker embeddings; and determining, from the speaker embeddings and the phoneme sequence, a synthesized speech waveform indicative of the reference speaker speaking the text data.

In some embodiments, the trained neural network comprises: a speech decoder; a speaker encoder; and a timbre transformer. In some embodiments, the method further comprises determining, from the phoneme sequence, a timbre-invariant frame-level phoneme representation.

In some embodiments, extracting speaker embeddings from the high-level speech representations comprises extracting the speaker embeddings from a frame-level speech representation of the reference speaker speaking the reference speech.

In some embodiments, determining the synthesized speech waveform comprises: extracting, by the speaker encoder, speaker embeddings from the high-level speech representation. In some embodiments, the speaker embeddings represent one or more of the reference speaker's timbre characteristics and the reference speaker's rhythm characteristics.

In some embodiments, determining the synthesized speech waveform comprises applying a lossless bidirectional transformation between the phoneme representation sequence and the speech representation sequence. In some embodiments, the trained neural network applies disentangled representation learning to extract the speaker embeddings from the high-level speech representation.

In some embodiments, determining the synthesized speech waveform further comprises: determining, by the timbre transformer, a timbre-dependent speech representation based on the timbre-invariant frame-level phoneme representation; and determining, by the speech decoder, based on the timbre-dependent speech representation, the synthesized speech waveform.

In some embodiments, the speaker encoder is trained by a phoneme leakage discriminator, configured to detect leakage phoneme information in outputs of the speaker encoder. In some embodiments, the phoneme leakage discriminator is configured to: receive, from the speaker encoder, speaker embeddings; and in response to detecting, based on the speaker embeddings, phoneme information leakage, apply an adversarial penalty to the speaker encoder. In some embodiment, the phoneme leakage discriminator improves the phoneme-speaker information disentanglement ability of the speaker encoder.

In some embodiments, the timbre transformer is configured to align the timbre characteristics of a test synthesized speech waveform and a ground truth speech waveform. In some embodiments, the timbre transformer performs lossless bidirectional transformations between timbre-dependent and time-invariant sequences. In some embodiments, the lossless bidirectional transformations fuse the speaker embeddings with the timbre-invariant phoneme representation to synthesize a timbre-dependent speech representation. In some embodiments, the timbre transformer comprises a plurality of affine coupling layers.

In some embodiments, the timbre transformer is configured to perform a reverse transformation to remove timbre information from the timbre-dependent speech representation to produce a timbre-invariant speech representation. In some embodiments, the timbre residual discriminator is configured to: detect the presence of residual timbre information in the timbre-invariant speech representation; and in response to detecting the presence of residual timbre information in the timbre-invariant speech representation, add a penalty to the timbre transformer to improve the inverse transformation.

In some embodiments, the neural network comprises a feed forward neural network. In some embodiments, the neural network comprises a zero-shot speaker adaptive text to speech model.

In some embodiments, the method further comprises training the neural network by: detecting, by a phoneme leakage discriminator, phoneme information leakage; and in response to detecting phoneme information leakage, apply an adversarial penalty to the speaker encoder.

According to another aspect of the present invention, there is provided a non-transitory computer readable medium comprising instructions stored thereon that, when executed by a processor, cause the processor to perform the method of any one of the claims.

According to another aspect of the present invention, there is provided a system for synthesizing a speech waveform from text data. The system comprising a processor configured to: determine, from the text data, a phoneme sequence; obtain a reference speech waveform comprising a high-level speech representation of a reference speaker speaking a reference speech; and apply a trained neural network to the reference speech waveform and the phoneme sequence to determine synthesized speech waveform indicative of the reference speaker speaking the text data.

### BRIEF DESCRIPTION OF DRAWINGS

The invention will now be described with reference to the accompanying drawings, in which:

FIG. 1 is a block diagram of system 100 for synthesizing a speech waveform from text data, according to an embodiment;

FIG. 2 illustrates a software data flow diagram of the model during a training procedure, according to an embodiment;

FIG. 3 is a software flow diagram of a text-to-speech inference procedure, according to an embodiment;

FIG. 4 is a software flow diagram of a voice conversion inference procedure, according to an embodiment;

FIG. 5 comprises equations applied to the timbre residual discriminator and the phoneme leakage discriminator, according to an embodiment;

FIG. 6 is a graph depicting the effect of reference speech length on SMCS, according to an embodiment;

FIG. 7 is a table illustrating the performance evaluation results for the model performing the zero-shot TTS inference procedure, according to an embodiment of the model under defined test conditions;

FIG. 8 is a table illustrating the performance evaluation results for the model performing the zero-shot VC inference procedure, according to an embodiment of the model under defined test conditions;

FIG. 9 is a table illustrating the performance evaluation results for the model performing the zero-shot TTS inference procedure, according to an embodiment of the model under defined test conditions;

FIG. 10 is a table illustrating the performance evaluation results in the context of the ablation studies on LibriTTSᵤₙₛₑₑₙ, according to an embodiment of the model under defined test conditions;

FIG. 11 is a visualisation of speaker encoder embeddings after principal component analysis (PCA) dimensionality reduction, without ablation studies #2 and #3 of FIG. 10, according to an embodiment of the model under defined test conditions;

FIG. 12 is a visualisation of speaker encoder embeddings after PCA dimensionality reduction, with ablation studies #2 and #3 of FIG. 10, according to an embodiment of the model under defined test conditions;

FIG. 13 is a flowchart illustrating the steps of the TTS inference procedure, according to an embodiment.

Various ones of the appended drawings merely illustrate example embodiments of the present disclosure and cannot be considered as limiting its scope.

### DESCRIPTION OF EMBODIMENTS

While most research into speech synthesis has focused on synthesizing high-quality speech for in-dataset speakers, an equally essential yet unsolved problem is synthesizing speech for unseen speakers who are out-of-dataset with limited reference data, i.e., speaker adaptive speech synthesis.

Speaker-adaptive speech synthesis or voice cloning is the process to synthesize a target speaker's natural speech from arbitrary text. To achieve this process speech synthesis system may have general text-to-speech capabilities and may be configured to capture the voice characteristics of the target speaker from a short reference speech and synthesize audio based on these characteristics.

Unlike general speech synthesis models, which are primarily evaluated based on the naturalness of the synthesized speech, models aiming for speaker-adaptive speech synthesis are also evaluated by how well the synthesized speech is indicative of the target speaker's speech characteristics. This may be assessed by qualitatively, or quantitatively, assessing the similarity of voice characteristics between the synthesized speech and the actual speech from the same speaker.

Speaker-adaptive speech synthesis software models may comprise trained neural networks that comprise a text-to-speech network and a speaker encoding network. During training, the speaker encoding network may extract the speaker's characteristics, such as unique rhythm (speaking rate) and timbre (voice characteristics), as a speaker embedding from the reference speech. Subsequently, the text-to-speech network may synthesize speech from any text using this speaker embedding as guidance. After training, this procedure can be applied to arbitrary speakers, thus achieving speaker-adaptive speech synthesis.

An example of a non-speaker-adaptive speech synthesis model, VITS, described in reference [3], consists of a conditional variational autoencoder with adversarial learning for end-to-end text-to-speech. The VITS model can synthesize high-quality speech for speakers that are available in the training set, using uncertainty modeling over latent variables and adversarial training. However, due to the constraints of the VITS architecture, it can only synthesize speech using the voices of speakers within its training dataset. This limitation makes the VITS model poorly suited for synthesizing personalized speech synthesis for unseen speakers.

Studies have proposed zero-shot speaker adaptive text-to-speech and voice conversion approaches aimed at synthesizing high-quality speech for in-dataset speakers. However, existing approaches suffer from the degradation of naturalness and speaker similarity degradation when synthesizing speech for unseen speakers (i.e., speakers not in the training dataset) due to the poor generalizability of the model in out-of-distribution data.

Recent research has proposed speaker adaptive speech synthesis to address the problem of poor generalizability. These approaches can be divided into two categories: few-shot speaker adaptation based speech synthesis and zero-shot speaker adaptation based speech synthesis.

Few-shot speaker adaptation approaches typically pre-train a speech synthesis model on multi-speaker datasets, then fine-tune the speech synthesis model with a few speech samples from the unseen speaker. Although these few-shot speaker adaptation approaches can achieve a good quality of synthesized speech, they often require several minutes of audio and text pairs with transcriptions, which can pose a challenge for most users of these approaches. Furthermore, the requirements of computational resources and transcriptions for fine-tuning may limit the application scenarios of these few-shot speaker adaptation approaches.

In contrast, zero-shot speaker adaptation based approaches jointly train a speaker encoder with a speech synthesis model. For instance, the VITS based zero-shot approach YourTTS, as described in reference [5], utilizes a speaker encoder to extract speaker embeddings from reference speech and then utilizes these speaker embeddings as input for YourTTS's speech synthesis model to generate speech for unseen speakers. Similarly, the StyleSpeech model, as described in reference [6], uses the same method to achieve zero-shot adaptation, and the Meta-StyleSpeech model, as described in reference

, introduces meta learning for StyleSpeech to improve the quality of synthesized speech.

These approaches offer a broad range of application scenarios; however, the limited capability of speaker embedding and distribution shift between seen and unseen speakers present challenges for the speech synthesis models' generalizability, resulting in performance gaps between seen and unseen speakers and poor model performance in zero-shot scenarios.

Speech contains highly entangled phoneme and timbre information. It is desirable to disentangle these two types of information to enhance the generalizability of zero-shot speaker-adaptive speech synthesis.

Provided herein is a speaker-adaptive speech synthesis model configured to address the limitations of non-speaker-adaptive synthesis models, which cannot produce speech for speakers not represented by the training set.

More specifically, provided herein is a generalizable zero-shot speaker adaptive text-to-speech (TTS) and voice conversion (VC) model, GZS-TV. GZS-TV (hereafter ‘the model’) introduces disentangled representation learning for both speaker embedding extraction and for timbre transformation to improve model generalization. Additionally, the model leverages the representation learning capability of a variational autoencoder to enhance the capacity of the speaker encoder and enrich speaker embedding.

The zero-shot speaker adaptive characteristics of the model enables the model to assimilate the voice traits of the speaker quickly from a short reference audio, resulting in audio synthesis based on the acquired real-time features. Embodiments of the model may enable users to generate synthesized audio with minimal effort and time.

Performance evaluation results, provided herein for an embodiment of the model, demonstrate that the model can synthesize high-quality speech in zero-shot scenarios and significantly reduce the quality gap between seen and unseen speakers.

### System Overview

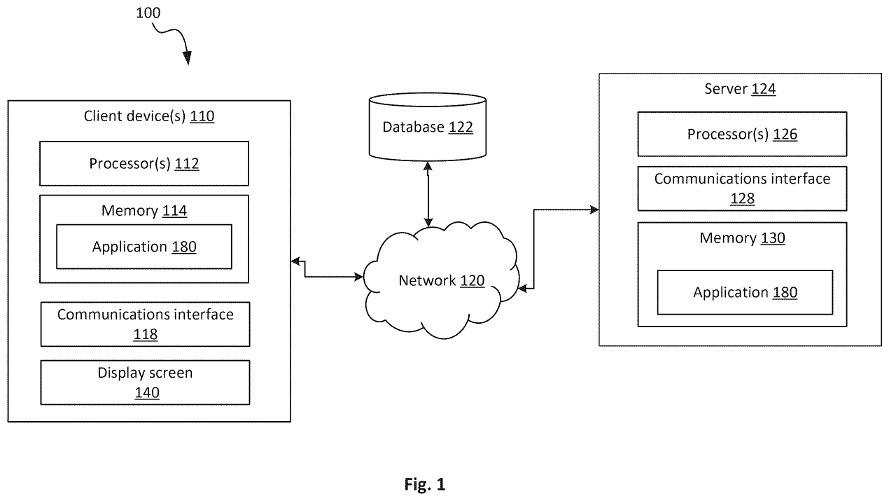

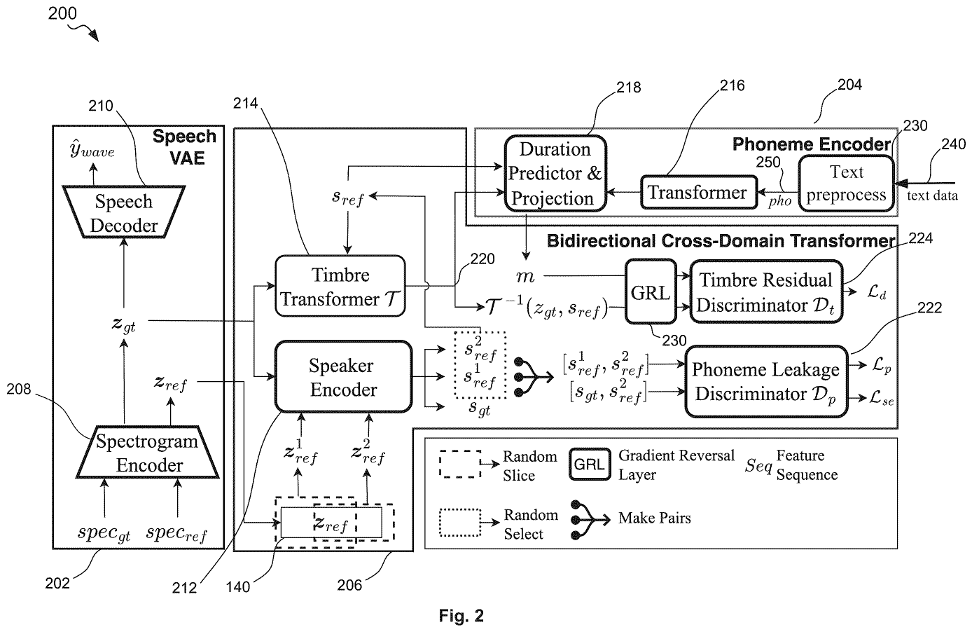

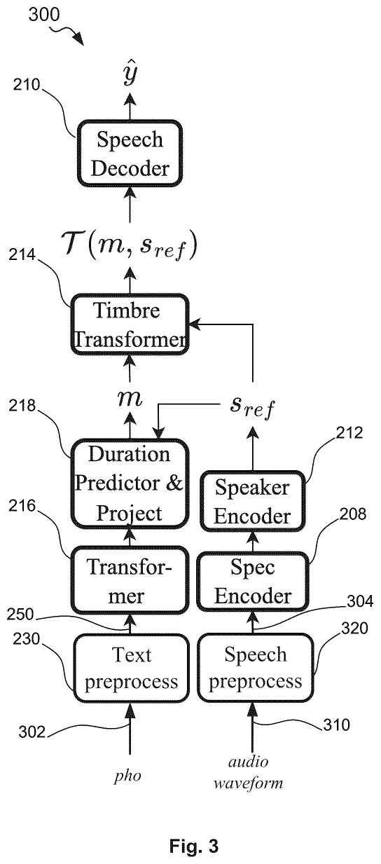

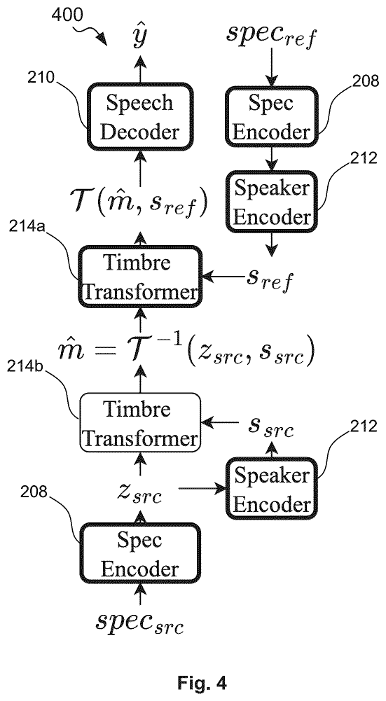

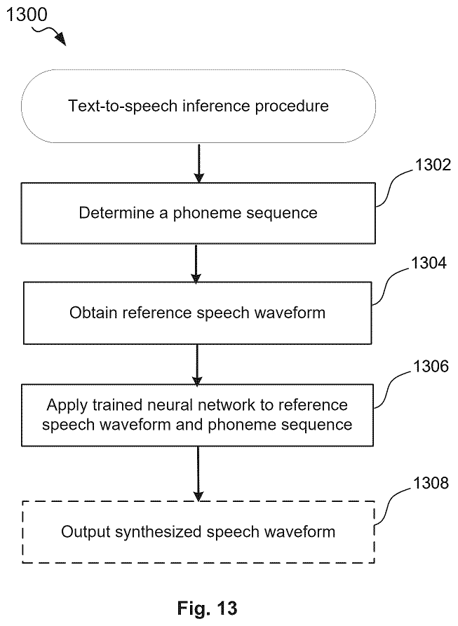

FIG. 1 is a block diagram of system 100 for synthesizing a speech waveform from text data, according to an embodiment. The system 100 of FIG. 1 provides means for executing an application 180, which comprises machine readable code defining the zero-shot speaker adaptive text-to-speech and voice conversion model (hereafter “the model”). Accordingly, system 100 provides means for implementing the methods as illustrated in data flow diagrams FIG. 2, FIG. 3 and FIG. 4, and process flow diagram FIG. 13.

As illustrated, the system 100 may comprise one or more client device(s) 110, external database 122, server 124, and/or one or more third party server(s) 170 in communication over a network 120.

Client device 110 may comprise a mobile or handheld computing device such as a smartphone or tablet, a laptop, or a PC, and may, in some embodiments, comprise multiple computing devices. The client device 110 may comprise one or more processor(s) 112, memory 114 and/or communications interface 118. The processor(s) 112 may comprise one or more microprocessors, central processing units (CPUs), application specific instruction set processors (ASIPs), application specific integrated circuits (ASICs) or other processors capable of reading and executing instruction code. The processor(s) 112 may be configured to receive stored instructions (i.e. program code) from memory 114, which when executed by the processor(s) 112 may cause the client device 110 to function according to the described embodiments. Client device 110 comprises one or more display screens 140, the or each of the one or more display screens 140 being configured to display the GUI in implementing a method, such as that illustrated in FIG. 13.

Functionality determining arrangement and content of the GUI is provided by the processor hardware 112, and the memory 114, which may be cooperating with the server 124.

The functionality of the system 100 may be defined by application 180. Application 180 may executed, in part or in full, on server 124. Machine-readable code (e.g. software) defining application 180 may be stored, in part or in full, on client device 110. Machine-readable code (e.g. software) defining application 180 may be stored, in part or in full, on server 124. The application 180 may receive inputs from database 122, or from other sources internal to the server 124, internal to the client 110, or accessible over the network 120. The application 180 may store the output products in database 122, in memory 130, memory 114, and/or transmit the output products over network 122.

The application 180 may be served by the server 124 to the client device 110 over the network 120.

The memory 114 may comprise application 180 which comprises computer executable code, which when executed by the one or more processors 112, is configured to allow client device 110 to facilitate the intuitive viewing and navigation of data displayed on a screen 140 of the client device 110. The communications interface 118 facilitates communications with components of the communications interface 118 across the network 120, such as: database 122, server 124 and/or third party server(s) 170. The communications interface 118 may comprise a combination of network interface hardware and network interface software suitable for establishing, maintaining and facilitating communication over a relevant communication channel.

The network 120 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 120 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

The database 122 may form part of or be local to the system 100, or may be remote from and accessible to the system 100, for example, via the communications network 120. The database 120 may be configured to store data associated with the system 100. The database 120 may be a centralised database. The database 120 may be a mutable data structure. The database 120 may be a shared data structure. The database 120 may be configured to store a current state of information or current values associated with various attributes (e.g., “current knowledge”).

The server 124 may be configured to serve single page applications to the client device 110. Single page applications may comprise graphical user interfaces (GUIs). The GUIs of single page applications provide a mechanism for a user of a client device to view, navigate, manipulate, and/or interact with, data stored by the application 180.

In some embodiments, the server 124 may comprise one or more processors 126 and memory 130 storing instructions (e.g. program code) which when executed by the processor(s) 126 causes the system 100 to function according to the described methods. The processor(s) 126 may comprise one or more microprocessors, central processing units (CPUs), application specific instruction set processors (ASIPs), application specific integrated circuits (ASICs) or other processors capable of reading and executing instruction code.

In some embodiments, the server 124 may operate in conjunction with or support one or more external devices, such as the client device 110, the database 122, and/or the third party server(s) 170, to manage the provision of an intuitive GUI for stored data.

The memory 130 may comprise one or more volatile or non-volatile memory types. For example, memory 130 may comprise one or more of random access memory (RAM), read-only memory (ROM), electrically erasable programmable read-only memory (EEPROM) or flash memory. Memory 130 is configured to store program code accessible by the processor(s) 126. The program code comprises executable program code modules. In other words, memory 130 is configured to store executable code modules configured to be executable by the processor(s) 126. The executable code modules, when executed by the processor(s) 126 cause the system 100 to perform the functionality according to the described embodiments, as described in more detail below.

### Modes of Operation

In embodiments, the model comprises one or more trained neural networks. The neural networks of the model are configured to undergo a training procedure 200 in which the model is trained to perform one or more of an TTS inference procedure, illustrated in FIG. 3, and a VC inference procedure, illustrated in FIG. 4.

In one embodiment, the model is configured to perform a text-to-speech (TTS) inference procedure, as exemplified by data flow diagram 300 in FIG. 3

In one embodiment, the model is configured to perform a voice conversion procedure, as exemplified in FIG. 4, in which the model takes as input audio waveform of a reference speaker speaking, and synthesizes the text-to-speech in accordance with the reference speaker's voice characteristics, to imitate the reference speaker speaking the input text data.

### Ground Truth, Reference and Source

As used herein, the subscripts gt, ref and src indicate that the corresponding sequences or embeddings come from the ground truth, reference, and source speech, respectively.

The ground speech is used only during the training procedure and is obtained from the seen speakers on the training set, providing phoneme-speech pairs for the model training procedure. The reference speech is also obtained from the same speakers as the GT speech during the training procedure, but it can come from any speaker (seen or unseen) during TTS and VC inference procedures. The reference speech provides timbre and rhythm information to guide speech synthesis, thereby achieving zero-shot speaker adaptation. The source speech is used only during VC inference and can be from any speaker, providing phoneme and rhythm information for the VC procedure.

### Training Procedure

FIG. 2 illustrates a software dataflow diagram of the model during a training procedure 200, according to an embodiment. The polygon shapes represent software modules, and the arrows between the polygon shapes indicate the flow of information from one software module to another software module.

In the embodiment illustrated in FIG. 2, the model under training comprises three parts: a speech variational autoencoder (VAE) 202, a phoneme encoder 204 and a bidirectional cross-domain transformer 206.

### Phoneme Encoder

In some embodiments, the phoneme encoder 204 comprises a text pre-processor module 230. In other embodiments, the phoneme encoder 204 is configured to receive processed text data from a text pre-processor module that is not incorporated into the model.

The text pre-processor 230 is configured to convert raw text data 240 containing symbols like numbers and abbreviations into the written equivalent of spoken-out words. This process may be referred to as text normalization or tokenization. The text pre-processor 230 then assigns phonetic transcriptions to each word. The text pre-processor 230 may also divide and mark the text into prosodic units, like phrases, clauses, and sentences. The process of assigning phonetic transcriptions to words is called text-to-phoneme or grapheme-to-phoneme conversion. Phonetic transcriptions and prosody information together make up the symbolic linguistic representation, also referred to as phoneme information 250 that is output by the text pre-processor 230.

The phoneme encoder 204 comprises a phoneme transformer 216 and a duration predictor and projection module 218. The phoneme encoder encodes and projects the phoneme information 250 from the text pre-processor 230 to a frame-level timbre-invariant phoneme representation m. The phoneme encoder encodes duration predictor and projection module 218 then predicts the duration of each phoneme at frame-level and projects each phoneme into multi-frame according to the predicted result.

During the training phase, the model is configured to align the frame-level timbre-invariant phoneme representation m, synthesized from the text data 240, and the frame-level timbre-invariant speech representation T⁻¹(z_{gt}, s_{ref}), extracted from ground truth audio spectrogram spec_{gt} 202.

During the TTS inference procedure 300, the model is configured to synthesise the phoneme information into an audio waveform ŷ_{wave}, which represents human speech.

### Variation Autoencoder

In one embodiment, the model leverages the representation learning capability of a variational autoencoder (VAE) to enhance the capacity of the speaker encoder, enrich speaker embedding and the quality of synthesized speech. In one embodiment, the speech VAE comprises the stochastic variational inference and learning algorithm, as described in [7].

The speech VAE 202 comprises a spectrogram encoder 208 and a speech decoder 210. During the training procedure, the spectrogram encoder 208 samples frame-level speech representations z_{gt} and z_{ref} from linear spectrograms spec_{gt} and spec_{ref}. Linear spectrogram spec_{gt} contains highly entangled phoneme, timbre and rhythm information from a ground truth speech. Linear spectrogram spec_{ref} contains highly entangled phoneme, timbre and rhythm information from a reference speech.

The speech decoder 210 reconstructs waveform audio ŷ_{wave} from the frame-level speech representation z_{gt}.

### Bi-Directional Cross Domain Transformer

The bidirectional cross-domain transformer 206 bridges the timbre-dependent domain (where z_{gt} belongs) and timbre-invariant domain (where m belongs) with disentangled representations learning.

The bidirectional cross-domain transformer 206 comprises a speaker encoder 212. The speaker encoder is configured to extract speaker embeddings, from the reference speech waveform 310, wherein the speaker embeddings represent a speaker's timbre characteristics and the speaker's rhythm characteristics. In embodiments, the speaker encoder is configured to extract the speaker embeddings from frame-level speech representations of the reference speech waveform. In one embodiment, the speaker encoder 212 is configured to extract speaker embeddings s_{gt} from frame-level speech representation z_{gt}. In one embodiment, the speaker encoder is further configured to extract speaker embeddings s¹_{ref} from frame-level speech representation z¹_{ref} and to extract speaker embeddings s²_{ref} from frame-level speech representation z²_{ref}, where z¹_{ref} and z²_{ref} are the sub-sequences of z_{ref}.

The spectrogram encoder's 208 representation learning capability can simplify the distribution of speaker embeddings given the frame-level speech representations and enable the speaker encoder 212 to learn richer embeddings, leading to better generalization for unseen speakers.

In one embodiment, the speaker encoder 212 is built upon the speaker verification model ECAPA-TDNN, as described in [10]. To obtain the speaker embedding, the speaker encoder 212 comprises feedforward layers, which replace the classifier layers of ECAPA-TDNN.

The bidirectional cross-domain transformer 206 further comprises a timbre transformer 214. The timbre transformer is configured to perform lossless bidirectional transformations. In one embodiment, the timbre transformer is configured to perform forward transformations and reverse transformations.

The timbre transformer 214 is configured to perform the forward transformation as part of the TTS inference procedure 300 and as part of the VC inference procedure 400. The forward transformation fuses the speaker embedding s_{ref} with the timbre-invariant phoneme representation m to synthesize a timbre-dependent speech representation, e.g., transforming m into T (m, s_{ref}) in FIG. 3.

The reverse transformation disentangles and removes the timbre information from the timbre-dependent speech representation based on the speaker embedding and produces a timbre-invariant speech representation.

In one embodiment, the timbre transformer 214 is configured to perform a reverse transformation during the training procedure, to transform z_{gt} into the timbre-invariant speech representation T⁻¹(z_{gt}, s_{ref}), as output on line 220. The reverse transformation is used during the training procedure and the VC inference procedure 400. Subsequently, two discriminators are designed to improve the model's generalizability on unseen speakers.

### Development Baseline

The model is developed on the VITS baseline, which is similar to YourTTS. In contrast to YourTTS, the model removes the requirement for speaker embedding as an input for the speech VAE, so that we can extract the speaker embedding from the latent speech representation. Furthermore, design two discriminators to enhance the model's generalizability to unseen speakers.

### TTS Inference Procedure

FIG. 3 is a software flow diagram 300 of the TTS inference procedure, according to an embodiment. The software flow diagram 300 illustrates software modules of the model, in rounded rectangles, and the data flowing between the software modules during the TTS inference procedure. FIG. 13 is a flowchart illustrating the steps of the TTS inference procedure, according to an embodiment.

In the TTS inference procedure, the model takes as input text data 302 representing words to be synthesized as speech. The model further takes as input a reference speech waveform 310, which is pre-processed by the speech pre-processor 320 (e.g. through Short-time Fourier transform, as described in reference [16]) to produce a linear spectrogram spec_{ref} 304. The linear spectrogram spec_{ref} 304 contains highly entangled phoneme, timbre and rhythm information from a reference speech spoken by a reference speaker. The model outputs an audio waveform ŷ, which represents the text data 302 being spoken by the reference speaker.

During the TTS inference procedure 300, in step 1302, the model is configured to determine from the text data, a phoneme sequence pho 250. The model is further configured to encode the phoneme sequence pho to a timbre-invariant frame-level phoneme representation m, In step 1304, the model is configured to obtain a reference speech waveform y_{ref} 310. The model is configured to determine, from reference speech waveform y_{ref} 310, a linear spectrogram spec_{ref} 304. The model is further configured to extract a speaker embedding s_{ref} from the linear spectrogram spec_{ref} 304 of the reference speech waveform y_{ref}.

In step 1306, the model is configured to transform the timbre invariant frame-level phoneme representation m into a timbre-dependent speech representation T (m, s_{ref}) according to the speaker embedding extracted in step 1304. The model is further configured to generate, and output in step 1308, the synthesized speech waveform ŷ from the timbre-dependent speech representation T (\hat{m}, s_{ref}). In particular, in step 1306, the model is configured to apply the trained neural network to the high-level speech representation of a reference speaker speaking a reference speech, to extract speaker embeddings. In embodiments, the model is configured to extract hidden speech features from the reference speaker's audio and store the extracted hidden speech features as speaker embeddings. In embodiments, hidden speech features, may comprise, but are not limited to: semantic; tone; pitch; emotion; and pacing.

Furthermore, in step 1306, the model is configured to determine, from the speaker embeddings and the phoneme sequence, a synthesized speech waveform indicative of the reference speaker speaking the text data.

### Reference Speech

In some embodiments, the TTS inference procedure may comprise, obtaining, from a reference speaker, an audio waveform of the reference speaker speaking a reference speech. In some embodiments, the VC inference procedure may comprise, obtaining, from a reference speaker, an audio waveform of the reference speaker reciting a reference speech. In some embodiments, the reference speech comprises a predefined set of words spoken by the reference speaker. The predefined set of words may be configured to provide a sufficient range of phoneme characteristics in the reference speech. In some embodiments, the reference speech comprises at least a minimum number of spoken words. In some embodiments, the reference speech comprises at least 5 spoken words. Preferably, the reference speech comprises at least 20 spoken words. In some embodiments, the reference speech is at least a minimum duration. In some embodiments, the reference speech comprises at least 2 seconds of spoken words. Preferably, the reference speech comprises at least 6 seconds of spoken words.

### VC Inference Procedure

FIG. 4 is a software flow diagram of the VC inference procedure 400, according to an embodiment. During VC inference procedure, the model is configured to apply the speaker encoder 212 to extract speaker embeddings s_{src} and s_{ref} from the source speech spec_{src} and reference speech spec_{ref}, respectively. The VC inference procedure can modify the speech of a source speaker and makes their speech sound like that of another target speaker without changing the linguistic information.

The model is further configured to apply the reverse transformation function 214b of the timbre transformer 214 to transform the spectrogram spec_{src} to a timbre-invariant phoneme representation \hat{m} conditioned on s_{src}.

The model is further configured to apply the forward transformation function 214a of the timbre transformer 214 to transform \hat{m} into a timbre-dependent speech representation T (\hat{m}, s_{ref}).

The model is configured to apply the speech decoder 210 to generate the synthesized speech waveform ŷ from the timbre-dependent speech representation.

The synthesized speech waveform ŷ represents the speech waveform of the source speaker, synthesised with the speaker characteristics of the reference speaker, such that the synthesized speech waveform ŷ sounds as though the speech has been spoken by the reference speaker.

### Extracting Speaker Embedding from Latent Speech Representation

A challenge in zero-shot speaker adaptation is extracting accurate and generalizable speaker embeddings from a short segment of reference speech.

The inventors have identified that, for some embodiments, extracting speaker embeddings from high-level speech representations can address this challenge and enhance the generalization of the extracted speaker embeddings, compared to extracting them from raw audio or spectrogram data.

In some embodiments, the high-level speech representations are sampled from infinite multidimensional Gaussian distributions. Thus for the same speech, countless high-level speech representations with subtle differences can be sampled. This can improve the model's generalization performance. Other speech representations are the same as those extracted from the same speech, which is not conducive to the generalization performance of the model.

In some embodiments, the extraction process of a high-level speech representation involves the removal of noise from speech recordings (e.g. audio waveforms). This noise removal helps the text-to-speech path of the model to focus on learning speech-related information without being hindered by background noise. Conversely, other voice representations contain all voice and background information, leading to the text-to-speech path of the model being misled by noise during the learning process.

In some embodiments, high-level speech representation will gradually increase the amount of information used to represent speech-related sound waves during the training procedure, thereby improving the quality of synthesized speech. In contrast, other speech representations have fixed bandwidths for all sound wave frequencies, making it impossible to adjust the amount of information used.

During each training step of the model, a speech sample is randomly selected from the same speaker as the ground truth speech and used as the reference speech. The spectrogram encoder then samples speech representation z_{ref} from this reference speech and divides the speech representation z_{ref} into two sub-sequences, z_{ref}¹ and z_{ref}², with an overlap of λₒₗ frames, where λₒₗ is a hyperparameter for the phoneme leakage discriminator 222.

Subsequently, the speaker encoder 212 extracts two speaker embeddings s¹_{ref} and s²_{ref} from z_{ref}¹ and z_{ref}², respectively. One of the speaker embeddings, s¹_{ref} or s²_{ref}, is randomly selected as an input for downstream modules to provide the speaker's timbre and rhythm information. Both of the speaker embeddings, s¹_{ref} and s²_{ref}, are used as input for the phoneme leakage discriminator 222.

### Disentangled Representation Learning

Disentangled representations learning is an unsupervised learning technique for neural networks, that breaks down, or disentangles, underlying features into narrowly defined variables and encodes them as separate dimensions, which may thereby improve the generalization performance of the model in unknown domains.

The model, provided herein, employs disentangled representation learning for both speaker information extraction and timbre transformation to avoid phoneme information leakage into the speaker embedding and to better align the timbre of synthesized speech with the ground truth (GT) speech, which may thereby improve the quality of synthesized speech.

### Disentangled Representation Learning for the Speaker Encoder to Avoid Information Leakage

In some embodiments, it is desirable that the speaker embedding remains free from any leaked speaker-irrelevant information, particularly phoneme information which could hinder the generalizability of the speaker encoder 212 on unseen speakers. Accordingly, the model comprises a phoneme leakage discriminator 222, which is configured to detect leakage phoneme information and improve the ability of the speaker encoder 212 to disentangle phoneme information from speaker information, thus avoiding the phoneme information contamination of the speaker information.

During the training procedure, the speaker encoder 212 extracts an additional speaker embedding s_{gt} from the GT speech, in addition to the s¹_{ref} and s²_{ref} embeddings. From these three speaker embeddings, two contrastive embedding pairs are constructed: [s¹_{ref}, s²_{ref}] and [s_{gt}, s²_{ref}].

The speaker encoder 212 is configured to extract the first pair, [s¹_{ref}, s²_{ref}], from overlapped speech representations. The first pair, [s¹_{ref}, s²_{ref}], may include overlapping phoneme information if there is a phoneme information leakage issue in the speaker encoder 212.

On the other hand, the speaker encoder 212 is configured to extract the second pair, [s_{gt}, s²_{ref}], from different speech representations. Accordingly, the second pair [s_{gt}, s²_{ref}], would include rare to no overlapping phoneme information, regardless of the existence of phoneme information leakage.

The phoneme leakage discriminator 222 is configured to determine, based on the two contrastive embeddings, [s¹_{ref}, s²_{ref}] and [s_{gt}, s²_{ref}], which pair of speaker embeddings contains more leaked phoneme information. Specifically, the phoneme leakage discriminator takes the three speaker embeddings sᵣ¹, s_{ref}² and s_{gt} as input, since the s_{ref}¹ and s_{ref}² are extracted from the same sentence, they contain overlapped phoneme information, the task of the phoneme leakage discriminator is to detect this overlapped phoneme information. Accordingly, the phoneme leakage discriminator 222 is configured to detect leakage phoneme information in outputs, [s¹_{ref}, s²_{ref}] and [s_{gt}, s²_{ref}], of the speaker encoder 212.

If, during the training procedure, the phoneme leakage discriminator 222 cannot distinguish which pair of speaker embeddings contains more phoneme leaked information, it may be assume that the phoneme leakage is negligible. Accordingly, it may be assumed that the speaker encoder 212 is sufficiently trained.

The phoneme leakage discriminator Dₚ 222 is configured to detect phoneme information leakage and apply an adversarial penalty to the speaker encoder 212 if the phoneme leakage discriminator detects phoneme leakage.

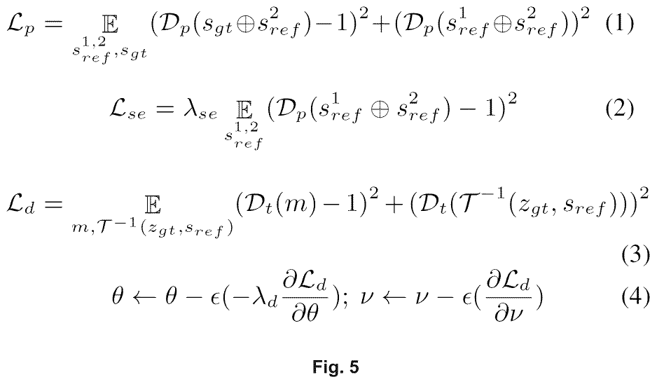

FIG. 5 comprises equations applied to the timbre residual discriminator 224 and the phoneme leakage discriminator 222, according to an embodiment. In one embodiment, the adversarial penalty Lₛₑ for the speaker encoder is determined in accordance with equation (2) of FIG. 5.

In one embodiment, the training loss for phoneme leakage discriminator Lₚ is determined in accordance with equation (1) of FIG. 5, where λₛₑ is a parameter that adjusts the weight of Lₛₑ and Dₚ refers to a feedforward neural network.

By playing this min-max game between the speaker encoder 212 and the phoneme leakage discriminator 222, the speaker encoder is expected to extract embeddings purely related to the speaker's information. Specifically, the phoneme leakage discriminator accepts two pairs of speaker embeddings as input. The first pair is extracted from overlapped speech representations and would include overlapping phoneme information if there is a phoneme information leakage issue in the speaker encoder. On the other hand, the second pair is extracted from different speech representations and would include rare to no overlapping phoneme information, regardless of the existence of phoneme information leakage. If a well-trained discriminator cannot distinguish which pair of speaker embeddings contains more leaked information, we can assume that the leakage is negligible and can be ignored.

### Disentangled Representation Learning for Timbre Transformer to Align Timbre Characteristics

In some embodiments, the model comprises a timbre residual discriminator 224. The timbre transformer 214 and the timbre residual discriminator 224 are configured to align the timbre characteristics of a test synthesized speech spec_{ref} and a ground truth speech spec_{gt}.

In one embodiment, the timbre transformer 214 is based on the normalizing flow in VITS, as described in reference [11].

In one embodiment, the timbre transformer 214 comprises multiple affine coupling layers, as described in reference [12], and provides bidirectional lossless transformations between timbre-dependent and time-invariant sequences to meet different requirements during the training and inference procedures.

Since the timbre transformer's transformation is bidirectional and lossless, enhancing its ability to disentangle and remove timbre information in speech representation during the reverse transformation is comparable to improving its ability to align the timbre information of synthesized and GT speech during the forward transformation.

In one embodiment, the timbre residual discriminator 224 is configured to detect the presence of residual timbre information in the output of the timbre transformer performing a reverse transformation.

In response to the timbre residual discriminator 224 detecting the presence of residual timbre information in the output of the timbre transformer 214, the timbre residual discriminator is configured to add a penalty to the timbre transformer to improve the reverse transformation of the timbre transformer. Specifically, in training procedure 200, two types of frame-level timbre-invariant representations are obtained. First, a phoneme representation m that is converted from a phoneme sequence, and is not influenced by any timbre-related information. Second, a speech representation T⁻¹(z_{gt}, s_{ref}) that is obtained by eliminating timbre information from high-level speech representations. However, complete elimination of timbre information is often not possible, hence, there may still be some residual timbre information in the speech representation. The role of the timbre residual discriminator is to identify and detect these residual timbre signals. If a well-trained discriminator is unable to detect any residual timbre information, the residual timbre information can be ignored without measurably adversely affecting the output synthesized speech.

In one embodiment, the timbre residual discriminator 224 comprises multiple Res2Net layers (as described in reference [13]), an attentive statistics pooling layer (as described in reference [14]) and a classification layer.

In one embodiment, during the training procedure, the timbre transformer 214 is configured to perform a reverse transformation, outputting the output sequence T⁻¹(z_{gt}, s_{ref}). The phoneme encoder 204 is configured to output the time-invariant sequence, as denoted by m, generated from the phoneme. During the training procedure, the timbre residual discriminator Dₜ 224 is configured to determine which of the output sequence T⁻¹(z_{gt}, s_{ref}) or the time-invariant sequence m does not contain timbre information.

In some embodiments, the bidirectional cross-domain transformer 206 further comprises a gradient reversal layer (GRL) 230, which is configured to invert the gradient. In one embodiment, the bidirectional cross-domain transformer 206 comprises a gradient reversal layer (GRL), as described in reference [15].

If the timbre residual discriminator 224 cannot detect the presence of residual timbre information in the output of the timbre transformer 214, the timbre transformer 214 may be considered sufficiently trained. That is the timbre transformer's reverse transformation process can disentangle and remove most of the timbre information from the source speaker's speech, and the timbre transformer's forward transformation process can sufficiently align the timbre information with the ground truth.

During the training process, the timbre transformer 214 and timbre residual discriminator 224 are optimized in different ways according to L_{d}, in accordance with equations (3) and (4) of FIG. 5.

In equations (3) and (4) of FIGS. 5, θ is the parameter of the timbre transformer, ν is the parameter of the timbre residual discriminator, ϵ is the learning rate, λ_{d} is a weight hyperparameter and T is timbre transformer.

### Indicative Speech

The systems and methods described herein are configured to synthesise a speech waveform that is indicative of a reference speaker speaking the text data. In other words, a listener of the synthesised speech waveform may consider that the synthesised speech waveform comprises a waveform of the reference speaker actually speaking the text data, because the synthesised speech waveform exhibits speech characteristics of the reference speaker. Whether the synthesised speech waveform is indicative of the reference speaker speaking the text data may be determined quantitatively by comparing the speech characteristics of the synthesised speech waveform with the speech characteristics of the reference speaker. Additionally or alternatively, whether the synthesised speech waveform is indicative of the reference speaker speaking the text data may be determined qualitatively by a listener.

### Performance Evaluation

An embodiment of the model was trained on the clean set of LibriTTS (which is described in reference [8] and downsampled all audio samples to 22050 Hz.

The inventors performed a performance evaluation on the model. During the performance evaluation, the λₛₑ and λ_{d} parameters were set to 8, and λₒₗ was limited to a range of 20% to 40% to avoid the timbre residual discriminator 224 overwhelming the timbre transformer 214.

A batch size of 64 was used, the AdamW optimizer (an embodiment of which is described in reference [16]) was employed with β₁=0.8, β₂=0.99, and the weight decay was set to 0.01. Additionally, the learning rate was initialized to 2×10⁻⁴, with a decay factor of γ=0.999875.

For this performance evaluation, the evaluation metrics comprised a mean opinion score (MOS) (as described in reference [4]) to evaluate the naturalness of synthetic speech. To evaluate the speaker similarity of synthetic speech, both the speaker embedding cosine similarity (SMCS) (an embodiment of which is described in reference

) and similarity mean opinion score (SMOS) were used. Both MOS and SMOS are rated on a 1-to-5 scale (1 means worst and 5 means best) by 30 native English speakers through the crowdsourcing form, reported with 95% confidence intervals.

The SMCS is computed by Resemblyzer (as described in [1]), which is an off-the-shelf tool for computing speaker embedding. A larger SMCS value indicates better speaker similarity. Accordingly, a larger SMCS value means the voice of the synthesized waveform is more similar to the actual voice of the speaker of the reference speech. Also, a larger SMCS value is associated with the synthesised waveform being more indicative of the reference speaker speaking the text data. The word error rate (WER) was also provided as the intelligibility metric, wherein a smaller WER indicates more explicitly synthesized speech. A public pre-trained ASR model (as described in [2]) for speech transcription was adopted.

For this performance evaluation, baselines approaches were applied. The performance of the model was compared with several baselines, including:
1) Ground-truth: Gt Speech;
2) Reconstruction: speech reconstructed from z_{gt} through speech decoder;
3) StyleSpeech, a speaker adaptive TTS approach based on style-adaptive layer normalization;
4) Meta-StyleSpeech, another version of StyleSpeech based on meta-learning: and
5) YourTTS, a current state-of-the-art zero-shot speaker adaptive TTS model in English, which is based on VITS, like the model provided herein.

For the performance evaluation, the inventors used the YourTTS public checkpoint, which is pre-trained on VCTK and fine-tuned on LibriTTS. By comparing the performance of the model with the performance of YourTTS, the inventors could demonstrate that the improved performance of the model does not solely result from using a more sophisticated speech synthesis backbone.

For the performance evaluation, both baselines 3) and 4) were trained on LibriTTS. Since baselines 3), 4) and 5) can only synthesize 16 kHz speech, the synthesized speech of the model was downsampled to 16 kHz when evaluating performance.

For the performance evaluation, the inventors utilized 37 out of 39 speakers in the LibriTTS test set (two speakers had insufficient samples) and 108 out of 109 speakers in the VCTK dataset (one speaker lost transcriptions) for the unseen speakers' TTS and VC evaluations.

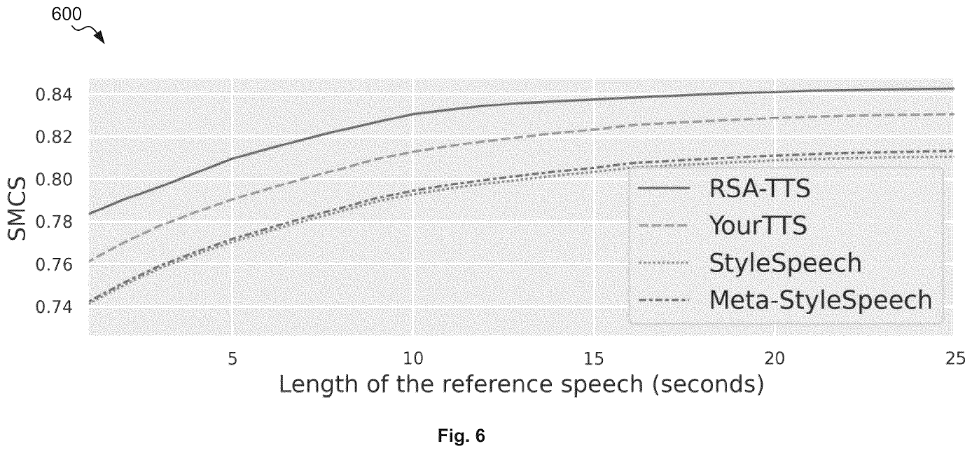

Additionally, 37 random speakers from the LibriTTS training set were selected to evaluate seen speakers. To ensure the diversity of the data, 5 test sentences for each LibriTTS speaker and 2 test sentences for each VCTK speaker were randomly chosen. Additionally, YourTTS's TTS experiment on LibriTTS was conducted for reference. Notably, the reference speech in this experiment is considerably longer than in other zero-shot speech synthesis experiments, leading to significantly better outcomes. Furthermore, the impact of reference speech length using SMCS on LibriTTS's unseen speakers was examined. FIG. 6 is a graph 600 depicting the effect of reference speech length on SMCS, according to an embodiment.

### Experimental Results

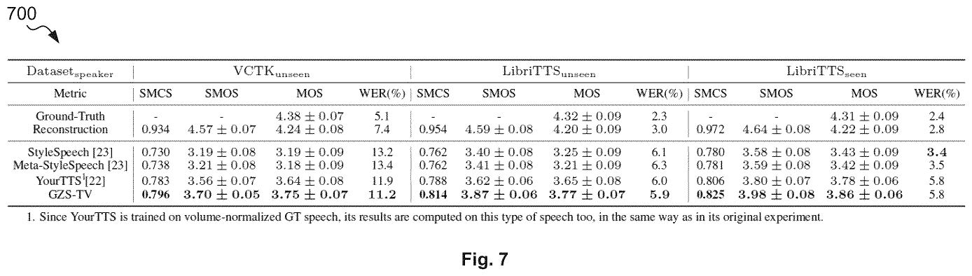

FIG. 7 is a table 700 illustrating the performance evaluation results for the model performing the zero-shot TTS inference procedure, according to an embodiment of the model under defined test conditions.

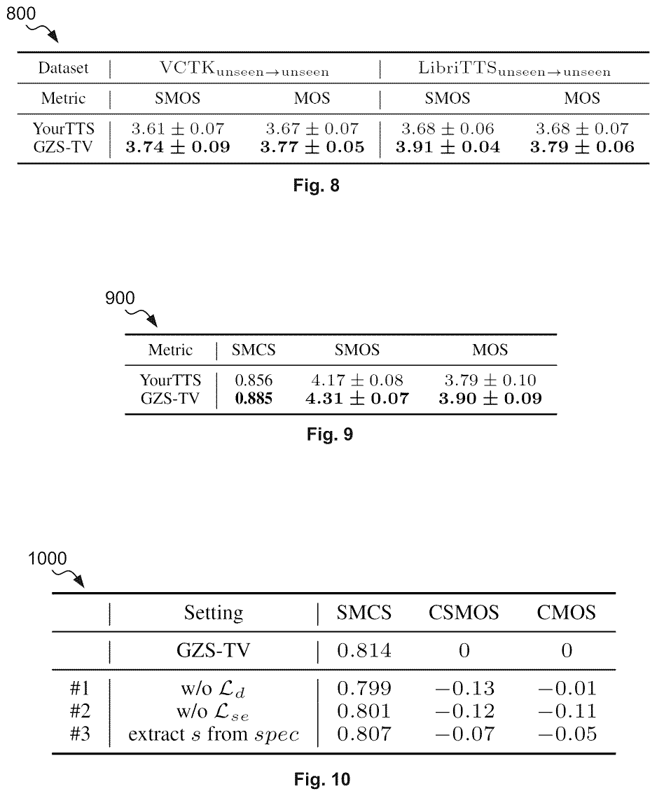

FIG. 8 is a table 800 illustrating the performance evaluation results for the model performing the zero-shot VC inference procedure, according to an embodiment of the model under defined test conditions.

The results of the performance evaluation demonstrate that the model reduces performance degradation on unseen speakers and outperforms all baseline models in multiple datasets. The TTS and VC experiments conducted on the LibriTTS dataset (as described in reference [8]) and the VCTK dataset (as described in reference [9]) demonstrate that the model is able to synthesize speech that is more natural and more similar to reference speaker's voice than recent state-of-the-art methods.

In particular, the results of the performance evaluation, as shown in tables 700 and 800, demonstrate that the model outperforms StyleSpeech, Meta-StyleSpeech, and YourTTS in almost all metrics. Firstly, the model exhibits good generalizability by effectively reducing the performance gaps between seen and unseen speakers. These results suggest that the model can handle out-of-dataset speakers better than other methods. It is noteworthy that YourTTS performs well on VCTK due to its pre-training on this dataset. However, despite using the same speech synthesis backbone as YourTTS, the model outperforms YourTTS regarding speaker similarity on both seen and unseen speakers, thanks to its disentanglement learning of speaker encoder and timbre transformer. Additionally, cross-dataset speaker adaptation remains challenging, as evidenced by the significant disparities in results on the unseen speakers of LibriTTS and VCTK datasets for all approaches.

FIG. 9 is a table 900 illustrating the performance evaluation results for the model performing the zero-shot TTS inference procedure, according to an embodiment of the model under defined test conditions. The test conditions, under which the results of table 900 were obtained, were substantially the same as the TTS experiment conducted in the original YourTTS paper (reference [5]); however, the test conditions specified a much longer reference speech than the experiments which we showed in FIG. 7.

### Ablation Studies

To verify the effectiveness of each module, the inventors conducted ablation studies. FIG. 10 is a table 1000 illustrating the performance evaluation results in the context of three ablation studies, (#1), (#2), and (#3), on LibriTTSᵤₙₛₑₑₙ, according to an embodiment of the model under defined test conditions.

As illustrated by table 1000, removing L_{d} (#1) led to a drop in speaker similarity, while removing Lₛₑ (#2) and using direct extraction (#3) resulted in reduced speaker similarity and naturalness. An ablation study was also conducted on the VCTK dataset to investigate the effect of (#2) and (#3) on the speaker encoder 212.

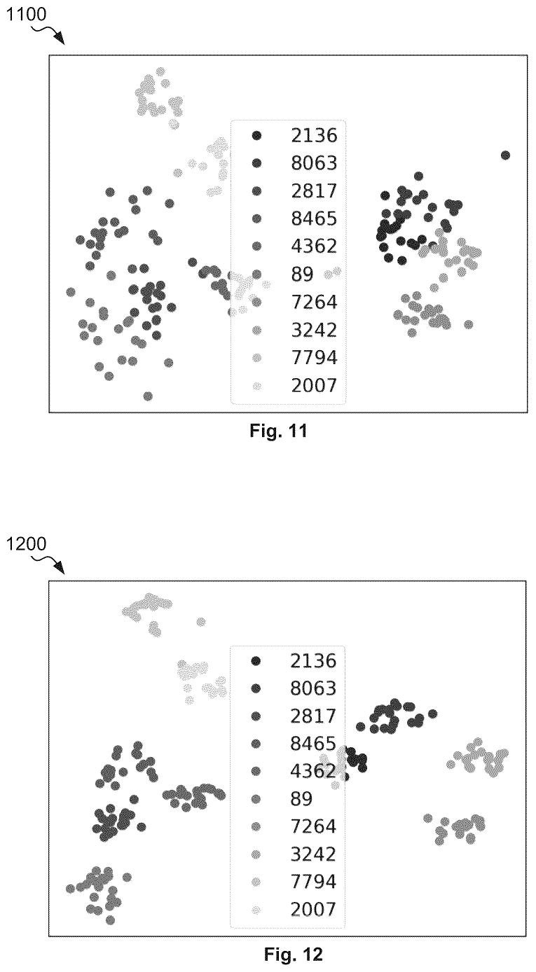

FIG. 11 is a visualisation of speaker encoder embeddings after principal component analysis (PCA) dimensionality reduction, without (#2) and (#3), according to an embodiment of the model under defined test conditions.

FIG. 12 is a visualisation of speaker encoder embeddings after PCA dimensionality reduction, with (#2) and (#3), according to an embodiment of the model under defined test conditions. Upon observation, incorporating (#2) and (#3) enhances the speaker encoder's ability to differentiate between various speakers. Simultaneously, incorporating (#2) and (#3) improves the grouping of speaker embeddings extracted from the same speaker, indicating the good independence of phoneme information within the speaker embedding.

The visualization results in FIGS. 11 and 12 demonstrate that both (#2) and (#3) may enhance the generalizability of the speaker encoder 212, reducing confusion and outliers when extracting embeddings for previously unseen speakers.

It will be appreciated by persons skilled in the art that numerous variations and/or modifications may be made to the above-described embodiments, without departing from the broad general scope of the present disclosure. Furthermore, it will be appreciated by persons skilled in the art that embodiments disclosed herein can be combined with one or more other embodiment disclosed herein, without departing from the broad general scope of the present disclosure. The present embodiments are, therefore, to be considered in all respects as illustrative and not restrictive.

References herein to software or executable instructions are to be understood as referring to executable instructions stored in volatile or non-volatile memory. The memory can include any data storage device that can store data which can thereafter be read by a processor. Examples of memory include read-only memory (ROM), random-access memory (RAM), magnetic tape, optical data storage device, flash storage devices, or any other suitable storage devices.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### REFERENCES

[1] https://github.com/resemble-ai/Resemblyzer
[2] https://huggingface.co/facebook/wav2vec2-large-960h-lv60-self
[3] J. Kim, J. Kong, and J. Son, “Conditional variational autoencoder with adversarial learning for end-to-end text-to-speech,” in Proc. of ICML, vol. 139, 2021, pp. 5530-5540.
[4] M. Chen, X. Tan, B. Li, Y. Liu, T. Qin, S. Zhao, and T. Liu, “Adaspeech: Adaptive text to speech for custom voice,” in Proc. of ICLR, 2021.
[5] E. Casanova, J. Weber, C. D. Shulby, A. C. Junior, E. Golge, and M. A. Ponti, “Yourtts: Towards zero-shot multi-speaker TTS and zero-shot voice conversion for everyone,” in Proc. of ICML, vol. 162, 2022, pp. 2709-2720.
[6] D. Min, D. B. Lee, E. Yang, and S. J. Hwang, “Meta-stylespeech: Multi-speaker adaptive text-to-speech generation,” in Proc. of ICML, vol. 139, 2021, pp. 7748-7759.
[7] D. P. Kingma and M. Welling, “Auto-encoding variational bayes,” in Proc. of ICLR, 2014.
[8] H. Zen, V. Dang, R. Clark, Y. Zhang, R. J. Weiss, Y. Jia, Z. Chen, and Y. Wu, “Libritts: A corpus derived from librispeech for textto-speech,” in Proc. of INTERSPEECH, 2019, pp. 1526-1530.
[9] V. Christophe, Y. Junichi, M. Kirsten, Y. Zhang, R. J. Weiss, Y. Jia, Z. Chen, and Y. Wu, “Cstr vctk corpus: English multi-speaker corpus for cstr voice cloning toolkit,” in University of Edinburgh. The Centre for Speech Technology Research (CSTR), 2016.
[10] B. Desplanques, J. Thienpondt, and K. Demuynck, “ECAPATDNN: emphasized channel attention, propagation and aggregation in TDNN based speaker verification,” in Proc. of INTERSPEECH, 2020, pp. 3830-3834.
[11] D. J. Rezende and S. Mohamed, “Variational inference with normalizing flows,” in Proc. of ICML, vol. 37, 2015, pp. 1530-1538.
L. Dinh, J. Sohl-Dickstein, and S. Bengio, “Density estimation using real NVP,” in Proc. of ICLR, 2017.
[12] S. Gao, M. Cheng, K. Zhao, X. Zhang, M. Yang, and P. H. S. Torr, “Res2net: A new multi-scale backbone architecture,” IEEE Trans. Pattern Anal. Mach. Intell., vol. 43, no. 2, pp. 652-662, 2021.
[13] K. Okabe, T. Koshinaka, and K. Shinoda, “Attentive statistics pooling for deep speaker embedding,” in Proc. of INTERSPEECH, 2018, pp. 2252-2256.
[14] Y. Ganin and V. S. Lempitsky, “Unsupervised domain adaptation by backpropagation,” in Proc. of ICML, vol. 37, 2015, pp. 1180-1189.
[15] I. Loshchilov and F. Hutter, “Decoupled weight decay regularization,” in Proc. of ICLR, 2019.
[16] Portnoff, Michael, “Time-scale modification of speech based on short-time Fourier analysis,” in Proc. of ICASSP, 1981.

1. A method for synthesizing a speech waveform from text data, the method comprising:
determining, from the text data, a phoneme sequence;
determining, from the phoneme sequence, a timbre-invariant frame-level phoneme representation:
obtaining a reference speech waveform comprising a high-level speech representation of a reference speaker speaking a reference speech; and
applying a trained neural network to the high-level speech representation to: extract speaker embeddings; and
determine, from the speaker embeddings and the timbre-invariant phoneme representation, a synthesized speech waveform indicative of the reference speaker speaking the text data.

2. The method of claim 1, wherein the trained neural network comprises:
a speech decoder;
a speaker encoder; and
a timbre transformer.

3. The method of claim 2, wherein the speaker embeddings represent one or more of:
timbre characteristics of the reference speaker; and
rhythm characteristics of the reference speaker.

4. The method of claim 3, wherein the trained neural network has been trained, by applying disentangled representation learning, to extract the speaker embeddings from the high-level speech representation.

5. The method of claim 4, wherein
determining the synthesized speech waveform further comprises:
determining, by the timbre transformer, a timbre-dependent speech representation based on the timbre-invariant frame-level phoneme representation and the speaker embeddings; and
determining, by the speech decoder, based on the timbre-dependent speech representation, the synthesized speech waveform.

6. The method of claim 5, wherein determining the timbre-dependent speech representation comprises applying, by the timbre transformer, a lossless bidirectional transformation to the timbre-invariant frame-level phoneme representation and the speaker embeddings.

7. The method of claim 6, wherein the timbre transformer has been trained, by applying disentangled representation learning, to determine the timbre-dependent speech representation.

8. The method of claim 2, wherein the speaker encoder is trained by a phoneme leakage discriminator, configured to detect leakage phoneme information in outputs of the speaker encoder.

9. The method of claim 8, wherein the phoneme leakage discriminator is configured to:
receive, from the speaker encoder, speaker embeddings; and
in response to detecting, based on the speaker embeddings, phoneme information leakage, apply an adversarial penalty to the speaker encoder.

10. The method of claim 2, wherein the timbre transformer is configured to align timbre characteristics of a test synthesized speech waveform and a ground truth speech waveform.

11. The method of claim 2, wherein the timbre transformer performs lossless bidirectional transformations between timbre-dependent and time-invariant sequences.

12. The method of claim 11, wherein the lossless bidirectional transformations fuse the speaker embeddings with the timbre-invariant phoneme representation to synthesize a timbre-dependent speech representation.

13. The method of claim 2, wherein the timbre transformer comprises a plurality of affine coupling layers.

14. The method of claim 2, wherein the timbre transformer is configured to perform a reverse transformation to remove timbre information from the timbre-dependent speech representation to produce a timbre-invariant speech representation.

15. The method of claim 14, wherein the timbre residual discriminator is configured to:
detect the presence of residual timbre information in the timbre-invariant speech representation; and
in response to detecting the presence of residual timbre information in the timbre-invariant speech representation, add a penalty to the timbre transformer to improve the inverse transformation.

16. The method of claim 2, wherein the neural network comprises a feed forward neural network.

17. The method of claim 2, wherein the neural network comprises a zero-shot speaker adaptive text to speech model.

18. The method of claim 1, further comprising training the neural network by:
detecting, by a phoneme leakage discriminator, phoneme information leakage; and
in response to detecting phoneme information leakage, apply an adversarial penalty to the speaker encoder.

19. A non-transitory computer readable medium comprising instructions stored thereon that, when executed by a processor, cause the processor to:
determine, from a text data, a phoneme sequence;
determine, from the phoneme sequence, a timbre-invariant frame-level phoneme representation:
obtain a reference speech waveform comprising a high-level speech representation of a reference speaker speaking a reference speech; and
apply a trained neural network to the high-level speech representation to:
extract speaker embeddings; and
determine, from the speaker embeddings and the timbre-invariant phoneme representation, a synthesized speech waveform indicative of the reference speaker speaking the text data.

20. A system for synthesizing a speech waveform from text data, the system comprising one or more processors configured to, individually or in combination;
determine, from a text data, a phoneme sequence:
determine, from the phoneme sequence, a timbre-invariant frame-level phoneme representation:
obtain a reference speech waveform comprising a high-level speech representation of a reference speaker speaking a reference speech; and
apply a trained neural network to the high-level speech representation to:
extract speaker embeddings; and
determine, from the speaker embeddings and the timbre-invariant phoneme representation, a synthesized speech waveform indicative of the reference speaker speaking the text data.
